(19) United States
(12) Patent Application Publication
(10) Pub. No.: US 2008/0310277 A1
(43) Pub. Date: Dec. 18, 2008

(54) STORAGE DEVICE

(75) Inventor: Takayuki IWASE, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/034,168

(22) Filed: Feb. 20, 2008

(30) Foreign Application Priority Data
Jun. 18, 2007 (JP) 2007160776

(51) Int. Cl. G11B 33/02

(52) U.S. Cl. 369/75.11

(57) ABSTRACT

A storage device includes: a storage medium including a first and a second main surface; a first cover member disposed on the first main surface side; a second cover member in a frame shape disposed on the second main surface side corresponding to the first cover member; and a pair of hook portions connected to the second cover member and sandwiching outer edge portions of the first cover member.

### CROSS-REFERENCE TO RELATED APPLICATIONS

This application is based upon and claims the benefit of priority from the prior Japanese Patent Application No. 2007-160776, filed on Jun. 18, 2007; the entire contents of which are incorporated herein by reference.

### BACKGROUND OF THE INVENTION

1. Field of the Invention

The present invention relates to a storage device capable of storing information.

2. Description of the Related Art

There has been known a magnetic disk device with a thin structure which can be mounted in a PC (personal computer) card slot owing to a reduction in thickness of its head actuator, voice coil motor, and soon and improvement in layout and the like of such internal components (see, for example, Reference 1 (JP-A 2001-210058 (KOKAI)).

In the device described in the aforesaid document 1, its internal components are covered by a rectangular top cover and a rectangular bottom cover while being sandwiched by these top and bottom covers from above and under. Here, the bottom cover has a pair of sidewalls extending upright from a pair of opposed longer sides. A hook portion protrudes from each of the sidewalls, bending toward the other sidewall side. These hook portions are fitted to side portions of an upper surface of the top cover so as to sandwich the top cover from its outer edge sides. That is, in this device, a screwing work is not necessary for assembling the bottom cover, resulting in improved assembling workability, and further realizing a reduced size because a screwing portion is not provided.

There has been also proposed a magnetic disk device or the like in which opening portions intended for lightening are provided in a base portion and a cover portion covering internal components in order to reduce thickness and weight of the device and a plurality of beams are formed to radially partition these opening portions (see, for example, Reference 2 (JP-A 9-265771 (KOKAI)).

In the device described in Reference 2, the beams prevent rigidity of the base portion and the cover portion from decreasing due to the formation of the opening portions. Consequently, it is possible to realize reduction in thickness and weight of the device on one hand and to ensure rigidity necessary as a structure on the other hand.

In the device described in Reference 1, the screwing work and the like are not necessary. However, in this device, a work of fitting the hook portions of the bottom cover to the side portions of the upper surface of the top cover is relatively difficult. Concretely, in the assembling work of the bottom cover, its structure does not allow the simultaneous fitting of the both hook portions. Therefore, one of the hook portions is hooked to one of the side portions of the top cover. Next, the other hook portion is fitted to the other side portion while the other hook portion is once pulled (bent) outward in a direction in which it becomes apart from this other side of the top cover.

More specifically, to fit the aforesaid other hook portion, one longitudinal end portion of this other hook portion is first hooked to the aforesaid other side portion of the top cover. Thereafter, the whole hook portion is gradually fitted from this one end portion side toward the other end portion side. This work of fitting the hook portion little by little while bending the hook portion as described above is relatively difficult, and improvement is hoped for regarding this problem.

Here, a possible way to reduce a bending force of the hook portions is to select a relatively soft material as a material of the bottom cover. However, simply selecting a soft material results in decreased rigidity of the hook portions themselves. In this case, in accordance with the decrease in rigidity of the hook portions, a gripping force for keeping the hook portions staying on the side portions of the top cover in a hooked state lowers. As a result, the work of gradually fitting the other hook portion from the longitudinal end portion side to the other end portion side becomes difficult.

Further, the structure of the device in the document 2 is effective for reducing thickness and weight. However, this device still has a problem to be solved regarding assembling workability of the components.

### BRIEF SUMMARY OF THE INVENTION

It is an object of the present invention to provide a storage device realizing higher assembling workability of a member covering internal components from an outer side.

A storage device according to one aspect of the present invention includes: a storage medium having a first and a second main surface; a first cover member disposed on the first main surface side; a second cover member in a frame shape disposed on the second main surface side corresponding to the first cover member; and a pair of hook portions connected to the second cover member and sandwiching outer edge portions of the first cover member.

### BRIEF DESCRIPTION OF THE DRAWINGS

FIG. 1 is a general view of a magnetic disk device according to an embodiment of the present invention seen from an upper surface side.

FIG. 2 is a general view of the magnetic disk device in FIG. 1 seen from a bottom surface side.

FIG. 3 is an exploded perspective view of the magnetic disk device in FIG. 1 seen from the upper surface side.

FIG. 4 is an exploded perspective view of the magnetic disk device in FIG. 1 seen from the bottom surface side.

FIG. 5 is a cross-sectional view of the magnetic disk device taken along the A-A line in FIG. 1.

FIG. 6 is a cross-sectional view of the magnetic disk device in FIG. 1 with the other hook portion of a bottom cover not yet fitted thereto.

FIG. 7 is a detailed view of a B portion of the magnetic disk device in FIG. 1.

FIG. 8 is a perspective view of the magnetic disk device in FIG. 7 with the bottom cover being detached therefrom.

FIG. 9 is a perspective view showing a state where a work of fitting of the bottom cover to the magnetic disk device in FIG. 7 is underway.

FIG. 10 is a plane view of a bottom cover of an example included in the magnetic disk device shown in FIG. 1.

FIG. 11 is a plane view of bottom covers of comparative examples compared with the bottom cover in FIG. 10.

FIG. 12 is a table showing comparison results of the bottom covers shown in FIG. 10 and FIG. 11 respectively.

FIG. 13 is a perspective view showing a bottom cover of another embodiment different in structure from the bottom cover shown in FIG. 10.

FIG. 14 is a plane view showing a bottom cover of another embodiment different in structure from the bottom covers shown in FIG. 10 and FIG. 13 respectively.

FIG. 15 is a plane view showing a bottom cover of another embodiment different in structure from the bottom covers shown in FIG. 10, FIG. 13, and FIG. 14 respectively.

FIG. 16 is a plane view showing a bottom cover of another embodiment different in structure from the bottom covers shown in FIG. 10 and FIG. 13 to FIG. 15 respectively.

FIG. 17 is a plane view showing a bottom cover of another embodiment different in structure from the bottom covers shown in FIG. 10 and FIG. 13 to FIG. 16 respectively.

### DETAILED DESCRIPTION OF THE INVENTION

Hereinafter, the best mode for carrying out the present invention will be described based on the drawings.

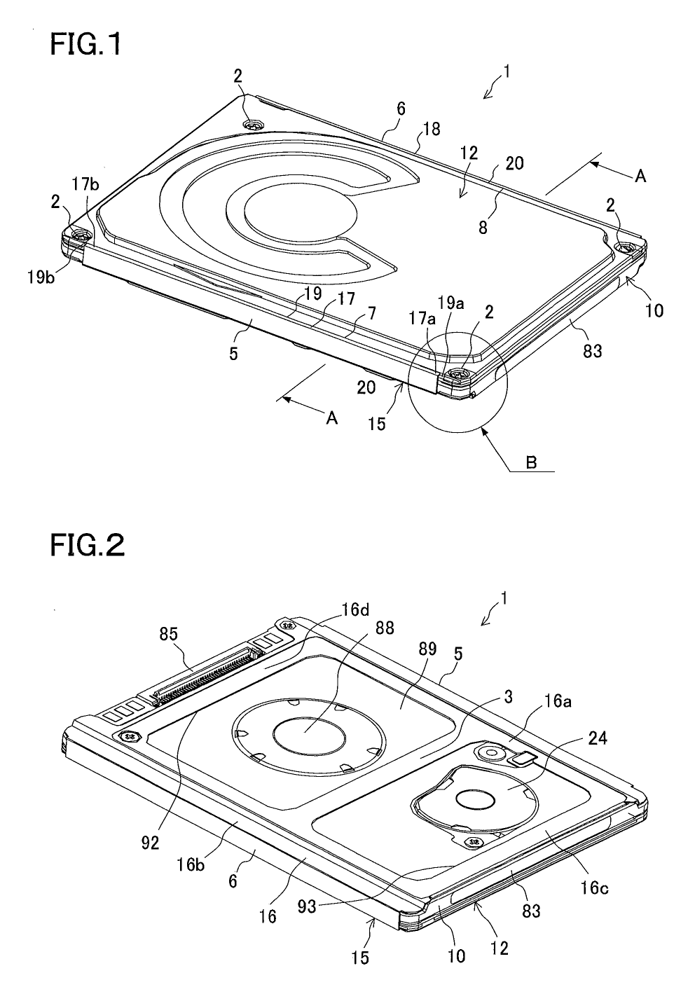

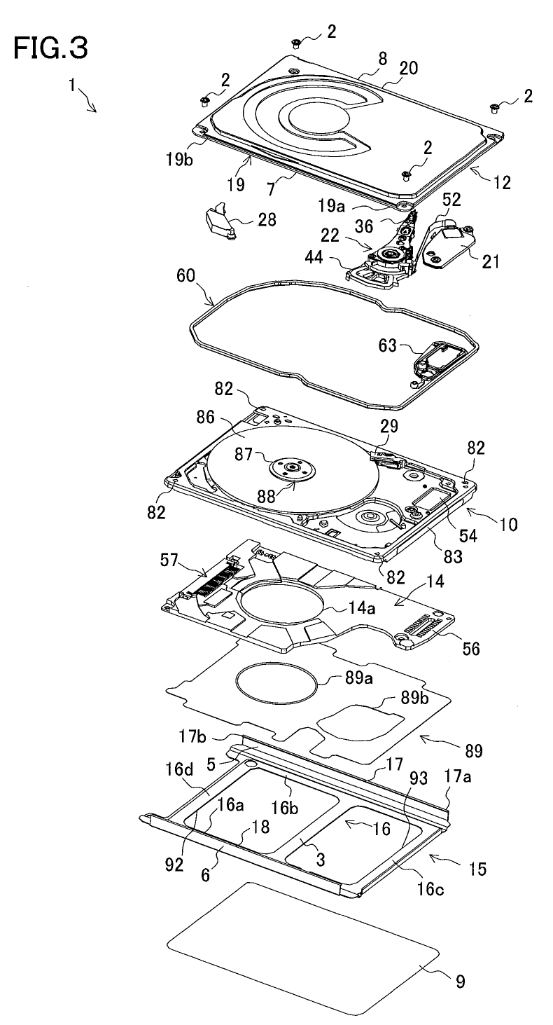

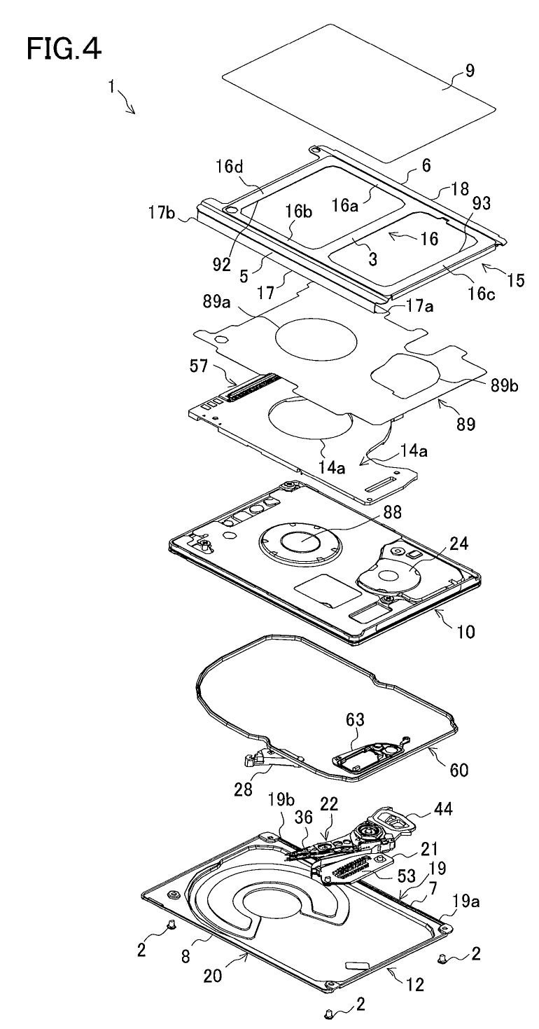

FIG. 1 is a general view of a magnetic disk device 1 as a storage device according to an embodiment of the present invention seen from an upper surface side, and FIG. 2 is a general view of the magnetic disk device 1 seen from a bottom surface side. FIG. 3 is an exploded perspective view of the magnetic disk device 1 seen from the upper surface side. FIG. 4 is an exploded perspective view of the magnetic disk device 1 seen from the bottom surface side. In FIG. 1 and FIG. 2, a caution label 9 is not shown.

As shown in FIG. 1 to FIG. 4, the magnetic disk device (magnetic disk drive) 1 is formed in a card shape, with, for example, a 0.5 mm thickness compliant with PC card type II standard. The magnetic disk device 1 includes a base 10 in a rectangular plate shape. In the base 10, a recessed portion in which later-described various members are mounted is formed in an area except its peripheral edge portion, and an upper surface side of the base 10 is open. In the magnetic disk device 1, a top cover 12, a printed circuit board 14, and a bottom cover 15 are stacked, and the whole magnetic disk device 1 is formed in the card shape. The top cover 12 closes the upper surface of the base 10 and functions as a plate-shaped first cover member. The printed circuit board 14 is provided on a bottom surface side of the base 10. The bottom cover 15 covers a bottom surface side of the printed circuit board 14 and the base 10 and functions as a second cover member.

As shown in FIG. 1 to FIG. 4, a 1.8 inch magnetic disk (platter) 86, a spindle motor 88, a plurality of magnetic heads, a head actuator 22, a voice coil motor (hereinafter, referred to as VCM) 24, a ramp load mechanism 29, a substrate unit 21, a pack-shaped air filter 28, and so on are housed in the recessed portion of the base 10. The magnetic disk 86 functions as a storage medium. The spindle motor 88 supports and rotates the magnetic disk 86. The magnetic heads write/read information to/from the magnetic disk 86. The head actuator 22 supports the magnetic heads so that the magnetic heads are movable relative to the magnetic disk 86. The VCM 24 makes the head actuator 22 pivot and positions the head actuator 22. The ramp load mechanism 29 keeps the magnetic heads at a position apart from the magnetic disk 86 when the magnetic heads move to the outermost periphery of the magnetic disk 86. The substrate unit 21 has a head IC and so on.

The top cover 12 covers the magnetic disk 86 from one side (upper surface side). The bottom cover 15 covers the magnetic disk 86 from the other side (bottom surface side). The top cover 12 and the bottom cover 15 are disposed at positions so as to substantially face each other across the magnetic disk 86.

The base 10 is formed by press forming of a magnetic material, for example, an iron-based material such as a cold-rolled steel plate. The peripheral edge portion of the base 10 is drawn toward a rear surface side. Further, a plurality of screw holes 82 used in screwing the top cover 12 to the base 10 are formed in the peripheral edge portion of the base 10.

As shown in FIG. 3 and FIG. 4, the head actuator 22 includes a bearing assembly, two arms, a magnetic head assembly 36, and a support frame 44. The bearing assembly is fixed on the base 10. The two arms extend from the bearing assembly. The magnetic head assembly 36 extends from tips of the arms. The support frame 44 extends from the bearing assembly in a direction opposite the direction in which the arms extend, and supports a voice coil. The magnetic head assembly 36 includes suspensions in a thin, long plate shape and magnetic heads. The magnetic heads are fixed to tips of the suspensions via gimbal portions not shown.

The VCM 24 making the head actuator 22 pivot includes the voice coil, an upper yoke, and a magnet. The voice coil is fixed to the support frame 44 of the head actuator 22. The upper yoke is provided on the base 10 to face the voice coil. The magnet is fixed to an inner surface of the upper yoke to face the voice coil. The base 10 which is made of the magnetic material also serves as a lower yoke of the VCM 24.

As shown in FIG. 3 and FIG. 4, each of the magnetic heads is electrically connected to the substrate unit 21 via a flexible cable 52. The substrate unit 21 is formed by a flexible printed circuit board. On a bottom surface of the substrate unit 21, a connector 53 for connection to the printed circuit board 14 is mounted. The substrate unit 21 is screwed to the base 10. The connector 53 faces a rectangular signal line insertion hole 54 formed in the base 10.

The base 10 has an air vent through which the inside and the outside of the base 10 communicate with each other. The air filter 28 is disposed to face the air vent. This air vent serves to eliminate a pressure difference between the inside and the outside of the base 10. At this time, the air filter 28 prevents dusts and the like from entering from the outside. Further, as shown in FIG. 1 and FIG. 2, a barcode label 83 or the like on which the serial number and the like of the product are recorded is stuck on a side end surface of the base 10.

The printed circuit board 14 provided on the bottom surface side of the base 10 is formed in a rectangular shape slightly smaller in size than the base 10, and has an opening 14a for avoiding the interference of a protruding portion of the base 10. A connector 56 is mounted on the printed circuit board 14. The connector 56 is connected to the connector 53 provided on the substrate unit 21 in the base 10 via the signal line insertion hole 54 of the base 10. Further, an I/F connector 57 for connecting the magnetic disk device 1 to an external device is connected to one longitudinal end of the printed circuit board 14.

The upper surface of the aforesaid base 10 is closed by the top cover 12 screwed to the base 10. As shown in FIG. 1 to FIG. 4, the top cover 12 is formed in a rectangular shape whose longitudinal dimension is larger than that of the base 10.

A sealing member 60 for keeping the inside of the base 10 airtight is interposed between the base 10 and the top cover 12. In a sealing portion 63 of the sealing member 60, a rectangular opening having a shape and a size corresponding to those of the signal line insertion hole 54 of the base 10 is formed. The sealing portion 63 is interposed between the base 10 and the substrate unit 21 when the substrate unit 21 is screwed to the base 10. Consequently, the sealing portion 63 airtightly seals the periphery of the signal line insertion hole 54 to prevent dusts and the like from entering the inside of the base 10 from the outside.

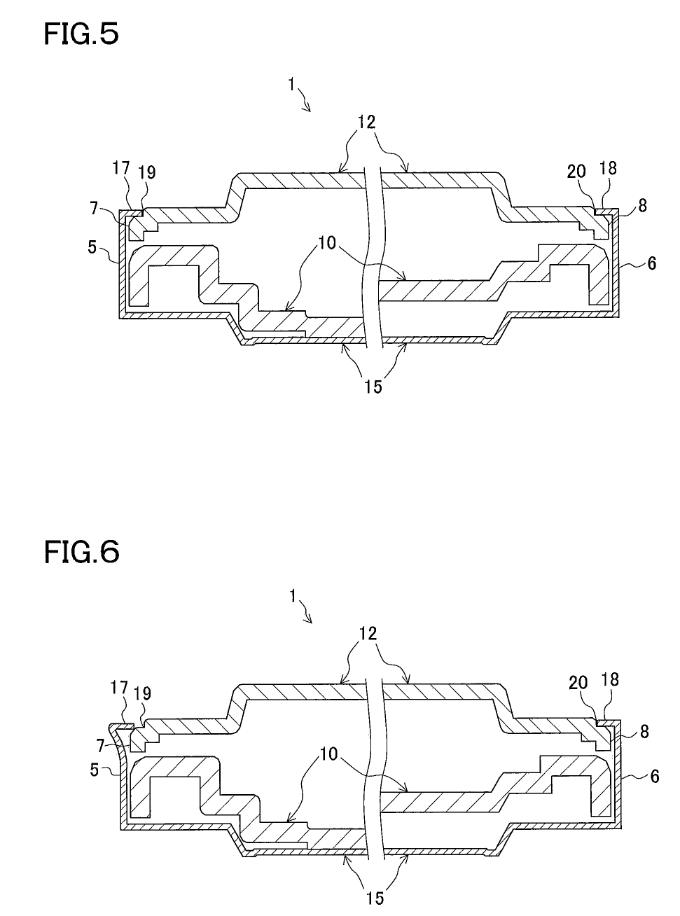

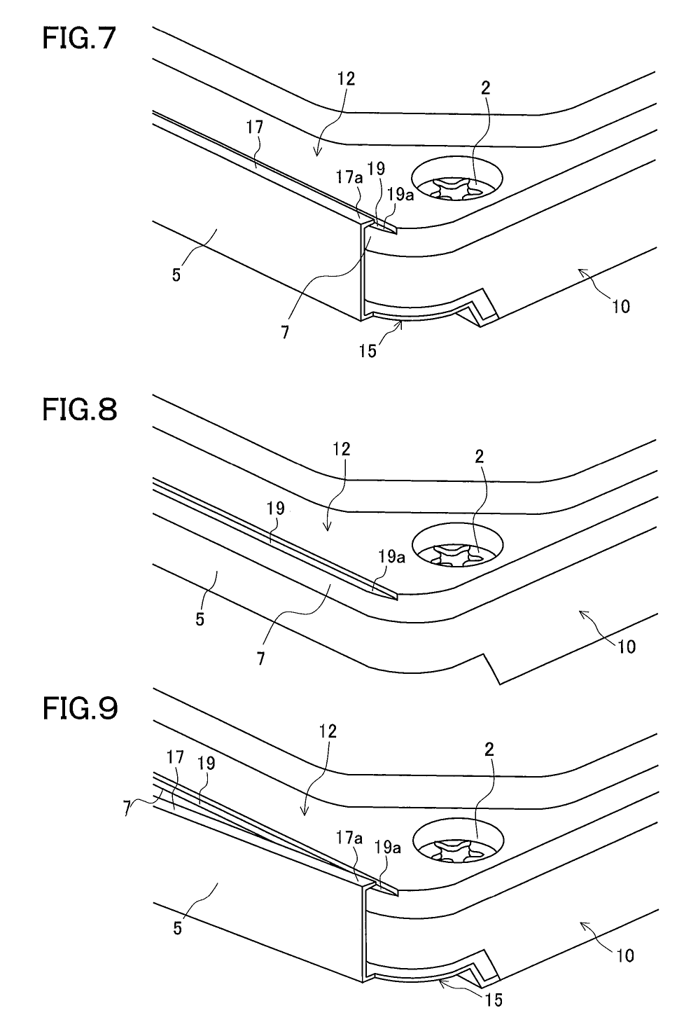

Next, the structure of the bottom cover 15 included in the magnetic disk device 1 of this embodiment will be described in detail based on FIG. 5 to FIG. 9 in addition to the aforesaid FIG. 1 to FIG. 4. Here, FIG. 5 is a cross-sectional view of the magnetic disk device 1 taken along the A-A line in FIG. 1. FIG. 6 is a cross-sectional view of the magnetic disk device 1 with the other hook portion 17 of the bottom cover 15 not yet fitted thereto. FIG. 7 is a detailed view of a B portion of the magnetic disk device 1 shown in FIG. 1. FIG. 8 is a perspective view of the magnetic disk device 1 with the bottom cover 15 being detached therefrom. FIG. 9 is a perspective view showing a state where a work of fitting the bottom cover 15 to the magnetic disk device 1 is underway.

As shown in FIG. 3 to FIG. 6, the bottom cover 15 is made of an aluminum steel plate material and formed in a rectangular frame shape so as to become light-weighted. Further, the bottom cover 15 has a pair of sidewalls 5, 6 extending upright from a pair of its opposed longer sides. The bottom cover 15 includes hook portions 17, 18 each protruding from one of the sidewalls 5, 6 so as to bend toward the other sidewall side. The hook portions 17, 18 are fitted to an upper surface of the top cover 12 so as to sandwich the top cover 12 from its outer edge portion sides.

Concretely, as shown in FIG. 3 to FIG. 9, in the outer edge portions of the upper surface of the top cover 12, a pair of side portions 7, 8 and a pair of stepped portions 19, 20 are formed. The pair of side portions 7, 8 face each other and extends substantially in parallel to each other. The pair of stepped portions 19, 20 are provided along the side portions 7, 8 respectively. The pair of hook portions 17, 18 on the bottom cover 15 are fitted along the pair of stepped portions 19, 20 of the top cover 12 respectively.

As shown in FIG. 1 to FIG. 4, the bottom cover 15 as structured above is attached to the top cover 12, being stacked on the bottom surface side of the printed circuit board 14 and an insulative film 89 having hole portions 89a, 89b. The aforesaid caution label 9 is stuck on the bottom surface of the bottom cover 15.

More specifically, as shown in FIG. 2, the bottom cover 15 includes a rectangular outer frame 16 having a pair of first frame body portions 16a, 16b and a pair of second frame body portions 16c, 16d. The pair of first frame body portions 16a, 16b are disposed in a direction along the side portions 7, 8 where the stepped portions 19, 20 of the top cover 12 are formed. The pair of second frame body portions 16c, 16d are disposed along a direction intersecting the side portions 7, 8 where the stepped portions 19, 20 are formed. The bottom cover 15 formed in the frame shape further includes a beam portion 3 extending inside the bottom cover 15. The beam portion 3 is provided for adjusting rigidity (mechanical strength) of the bottom cover 15 when the hook portions 17, 18 are fitted, and extends between the second frame body portions 16c, 16d.

Here, to assemble the bottom cover 15 as structured above, the hook portion 18 is first hooked to (engaged with) the stepped portion 20 of the top cover 12 as shown in FIG. 6. Next, the other hook portion 17 is fitted to the other stepped portion 19 of the top cover 12 as shown in FIG. 5 and FIG. 7 while once being pulled (bent) outward in a direction in which it becomes apart from this other stepped portion 19.

More specifically, to fit the other hook portion 17, one longitudinal end portion 17a of the other hook portion 17 is first hooked to one end portion 19a of the other stepped portion 19 of the top cover 12 as shown in FIG. 8 and FIG. 9. Thereafter, the whole hook portion 17 is gradually fitted from the one end portion 17a side to the other end portion 17b side (the other end portion 19b side of the stepped portion 19).

Here, as a material of the bottom cover 15 of this embodiment, aluminum steel which is relatively softer than stainless steel and the like is selected, and further, the bottom cover 15 is formed in the frame shape. As a result, it is possible to favorably perform a work of fitting the hook portion 17 while easily bending the whole bottom cover 15. The selection of the aluminum steel as the material gives rise to a concern that rigidity of the hook portions themselves (a gripping force for keeping the hook portions staying on the stepped portions) may lower and accordingly, the work of fitting the hook portions may become more difficult. Nevertheless, by forming the bottom cover 15 in the frame shape, it is possible to fit the hook portions after the whole bottom cover 15 is fully bent. This can improve assembling workability of the bottom cover 15. Here, the mechanical strength of the whole bottom cover 15 thus structured can be adjusted by the aforesaid beam portion 3. Accordingly, it is possible to practically ensure elasticity on a certain level or higher that the bottom cover 15 needs to have.

According to the magnetic disk device of this embodiment, it is possible to improve assembling workability of the bottom cover 15 covering internal components from the outer side and further realize weight reduction of the product.

Specifically, the second cover member having the hook portions can have increased elasticity owing to its frame-shaped structure. Accordingly, it is possible to fit the hook portions while bending the whole second cover member. Therefore, according to this embodiment, the work of fitting the hook portions (the work of assembling the second cover member) can be facilitated.

Further, according to this embodiment, a degree of freedom in setting the mechanical strength can be enhanced owing to the frame-shaped structure of the second cover member as described above. For example, if a high-hardness material is used as the material of the second cover member, the body portions of the frame are formed with a small width (an opening portion is made wide) for instance, and if a relatively low-hardness material is used, the body portions of the frame are formed with a large width (the opening portion is made narrow). Consequently, the second cover member can have elasticity and rigidity appropriate for the fitting work of the hook portions, which can enhance fitting workability of the hook portions, that is, enhance assembling workability of the second cover member.

Further, in this embodiment, the second cover member is formed in the frame shape for improved workability of fitting the hook portions, which as a result can realize weight reduction of the device.

### EXAMPLE

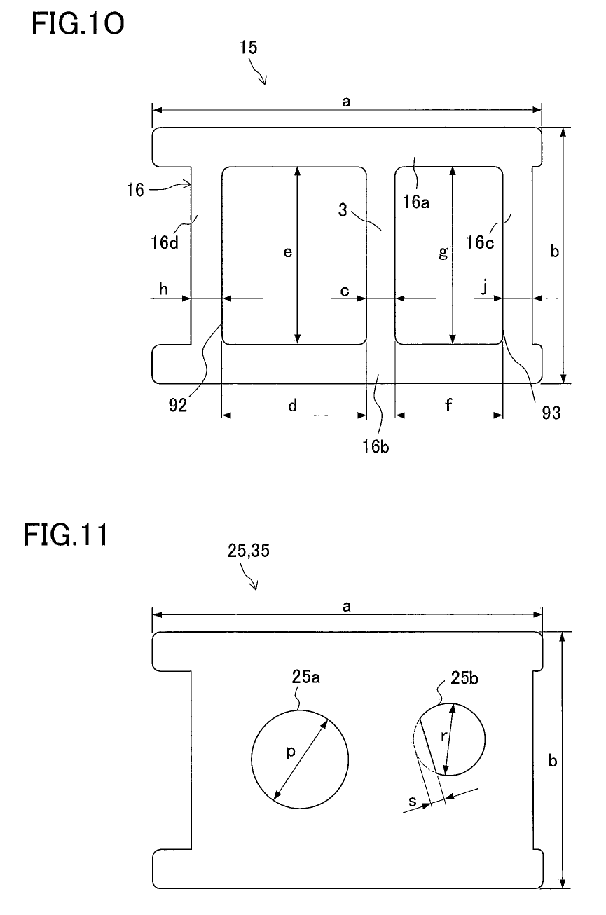

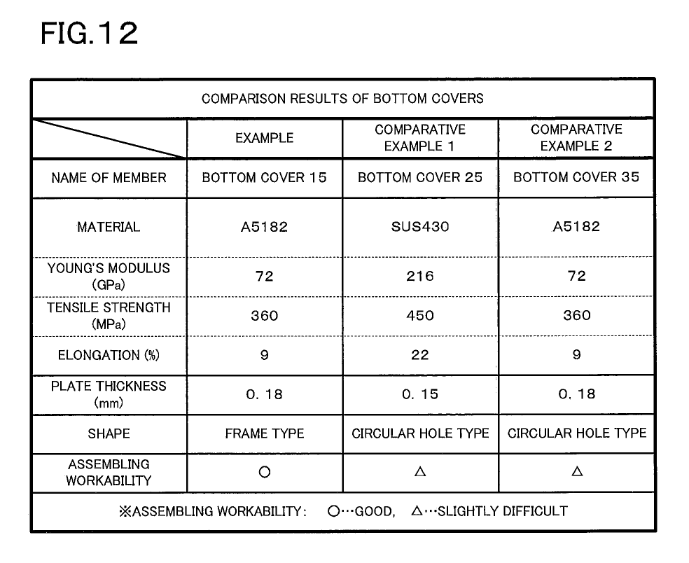

Next, the present invention will be described based on an example by using FIG. 10 to FIG. 12. Here, FIG. 10 is a plane view of a bottom cover 15 of the example included in the magnetic disk device 1 shown in FIG. 1. FIG. 11 is a plane view of bottom covers 25, 35 of comparative examples 1, 2 compared with the bottom cover 15 in FIG. 10. FIG. 12 is a table showing comparison results of the bottom covers shown in FIG. 10 and FIG. 11 respectively.

Here, dimensions shown in FIG. 10 and FIG. 11 are as follows: a=71 mm, b=51 mm, c, h, j=4 mm, d=29 mm, e, g=40 mm, f=23 mm, s=33 mm, p=diameter 23 mm, and r=diameter 19 mm. Therefore, in the bottom covers 25, 35 of a circular hole type of the comparative examples 1, 2, an area of an opening portion composed of hole portions 25a, 25b is 23.8% of an area of the whole outer surface. On the other hand, in the bottom cover 15 of a frame type of the example, an area of an opening portion composed of rectangular holes 92, 93 is 71.8% of an area of the whole outer surface. Further, in the example and the comparative example 2, A5182 is selected as an aluminum steel plate with a 0.18 mm thickness, and in the comparative example 1, on the other hand, SUS430 is selected as stainless steel with a 0.15 mm thickness. Characteristic values of the metallic materials are obtained under conditions compliant with JIS Z 2241 (tensile tests of metallic materials).

Under such conditions, the bottom covers were compared for assemblibility. As a result, in the comparative example 1 using SUS430 as the material, it was slightly difficult to fit hook portions because the whole bottom cover 25 was difficult to bend due to its high rigidity. In the comparative example 2 of the circular hole type in which a soft material (A5182) was simply selected, it was slightly difficult to fit hook portions due to a decreased gripping force for keeping the hook portions staying in a hooked state on the stepped portions of the top cover. On the other hand, in the example, it was possible to favorably perform the work of fitting the hook portions while easily bending the whole bottom cover 15.

### OTHER EMBODIMENTS

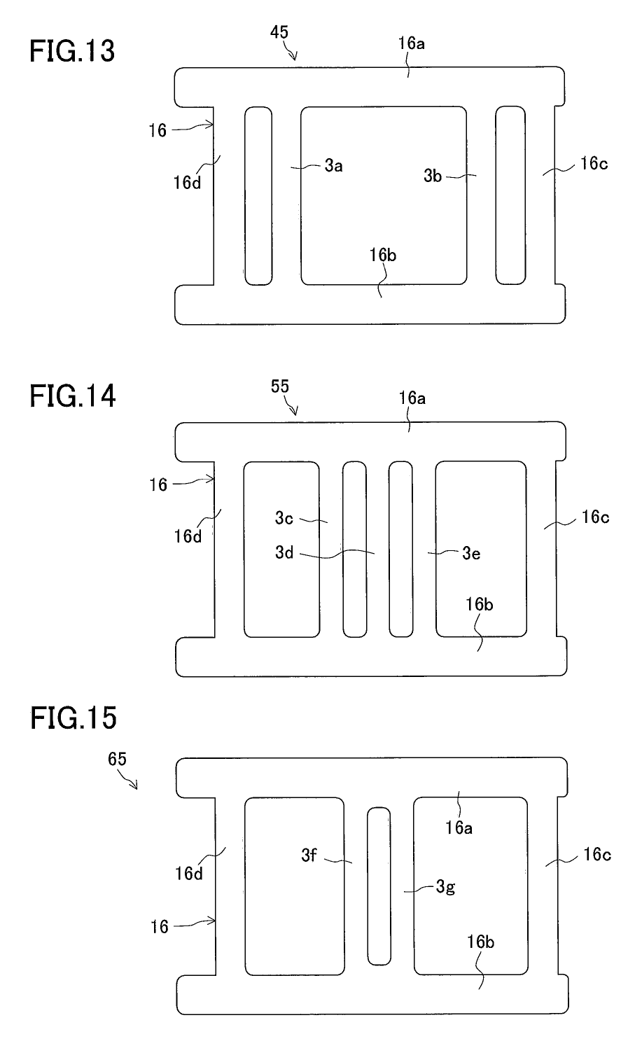

In the foregoing, the present invention is described based on the embodiment, but the present invention is not limited only to the above-described embodiment, and various changes can be made without departing from the spirit of the present invention. For example, in the above-described embodiment, the bottom cover has the beam portion only at one place. Instead, a plurality of beam portions may be provided to extend between the two frame body portions 16a, 16b in order to appropriately adjust rigidity of the whole bottom cover. Here, FIG. 13 shows, as an example, a bottom cover 45 having two beam portions 3a, 3b disposed near second frame body portions 16c, 16d respectively. FIG. 14 shows, as an example, a bottom cover 55 having three beam portions 3c, 3d, 3e disposed in a center portion of a gap between second frame body portions 16c, 16d. FIG. 15 shows, as an example, a bottom cover 65 having two beam portions 3f, 3g disposed in a center portion of a gap between second frame body portions 16c, 16d.

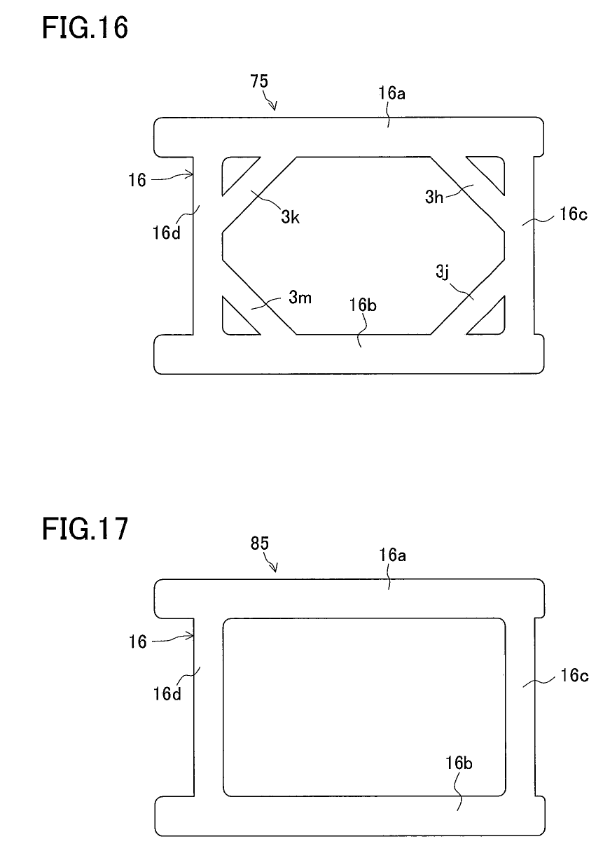

Alternatively, the beam portion may be provided so as to extend between the first frame body portion and the second frame body portion as shown in FIG. 16. A bottom cover 75 having four beam portions 3h, 3j, 3k, 3m extending in a manner shown in FIG. 16 may be used. Here, each of the beam portions 3h, 3j, 3k, 3m extends between a set among all the four sets of adjacent first and second frame body portions so as to subtend a corner portion of a rectangular outer frame 16. Another possible alternative when a relatively high-hardness material is selected is a bottom cover 85 without any beam portion as shown in FIG. 17.

Further, in the above-described embodiment, the storage device of the present invention is applied to the magnetic disk device using the magnetic disk as a storage medium, but the present invention is applicable not only to such a device but also to a disk drive using an optical disk or a magneto-optic disk, a storage device in which a semiconductor memory or the like is mounted as a storage medium, and the like. Further, in the above-described embodiment, the pair of hook portions are provided on the bottom cover, but two sets or more of the hook portions may be provided on the bottom cover.

What is claimed is:

1. A storage device, comprising:
a storage medium including a first and a second main surface;
a first cover member disposed on the first main surface side;
a second cover member in a frame shape disposed on the second main surface side corresponding to the first cover member; and
a pair of hook portions connected to the second cover member and sandwiching outer edge portions of the first cover member.

2. The storage device according to claim 1,
wherein the first cover member includes:
a pair of side portions disposed substantially in parallel to each other; and
a set of stepped portions formed along the side portions; and
wherein the pair of hook portions is fitted to the set of the stepped portions respectively.

3. The storage device according to claim 1, wherein
the second cover member includes a beam portion extending inside the cover member.

4. The storage device according to claim 1,
wherein the second cover member includes:
a rectangular outer frame including: a set of first frame body portions disposed substantially in parallel to each other; and a set of second frame body portions disposed in a direction intersecting the first frame body portions; and
a beam portion extending between the set of second frame body portions.

5. The storage device according to claim 4,
wherein the second cover member includes a plurality of the beam portions extending between the set of second frame body portions.

6. The storage device according to claim 1,
wherein the second cover member includes:
a rectangular outer frame having: a set of first frame body portions disposed substantially in parallel to each other; and a set of second frame body portions disposed in a direction intersecting the first frame body portions; and
a beam portion extending between the first and second frame body portions.

7. The storage device according to claim 6,
wherein the second cover member includes four beam portions each extending between a set among four sets of the first and second frame body portions.

8. The storage device according to claim 1,
wherein a material of the second cover member is aluminum steel.

9. The storage device according to claim 1,
wherein the storage medium is a magnetic disk.
